(19) United States
(12) Patent Application Publication
(10) Pub. No.: US 2005/0040152 A1
(43) Pub. Date: Feb. 24, 2005

(54) Thermoactive wall and ceiling element

(76) Inventors: Markus Koschenz, Wiesendangen (CH); Beat Lehmann, Schleinikon (CH); Stefan Holst, Icking (DE)

Correspondence Address: Edwin D Schindler;Five Hirsch Avenue, PO Box 966, Coram, NY, 11727-0966, US

(21) Appl. No.: 10/501,358

(22) PCT Filed: Feb. 3, 2003
(86) PCT No.: PCT/CH03/00081

(30) Foreign Application Priority Data
Feb. 1, 2002 (CH) 175/02

(51) Int. Cl. H05B 3/00

(52) U.S. Cl. 219/213; 392/339

(57) ABSTRACT

The thermoactive wall and ceiling element is installed in walls of newly built and old buildings and serves for its heating and cooling. It consists of a closed casing (2) which for intermediately storing heat comprises a phase change material (3) which melts when accommodating heat and reversely delivers latent heat to the surrounding on solidification. A lamellar design (8) with sound-absorbing material (4) therebetween is hung on this casing in a thermally separated manner by way of a heat-insulating material. At the bottom the lamellar design (9) is closed by a perforated ceiling sheet [metal] (plate) (5) in a heat-conducting manner, and this sheet metal (plate) forms the viewed ceiling of the room. The lamellar design encloses a heating and cooling pipe which is outwardly formed by the lamellar design as one piece or is connected to it is a heat-conducting manner. A displaceable heat-conducting heat contact body (24) is installed in the cavity (23) between the lamellar design (8) and the casing (2), and this body with all its parts creates a heat connection between the casing (2) and the lamellar design (8). An air gap (27) to the casing (2) arises, depending on its position, so that a thermal separation is achieved by it.

This invention relates to a thermoactive wall and ceiling element for installation in rooms of new buildings, and in particular old buildings. The wall and ceiling element is to contribute to a rational use of regenerative energy sources in order to adapt the room climate to the respective requirements in a more efficient and cost-saving manner. The element is suitable for lightweight constructions, such as for wooden constructions or constructions according to other lightweight construction systems. With regard to this, it is insignificant as to whether the ceiling element is installed in residential houses, that is to say detached or multiple dwelling houses, or in commercial buildings or industrial buildings. Basically, the element may be applied wherever rooms are to be cooled and/or heated. Commercially used buildings in particular always have building shells with an improved thermal insulation. When rebuilding and renovating, the facings (facades) are newly designed, better insulated and one incorporates considerably larger window areas in order to achieve very bright rooms and to give the building a lighter, more elegant and modern aesthetic appearance. New buildings are built from the very outset so as to have as good as possible heat insulation properties. At the same time however the use of increased technology is becoming more and more prevalent in such buildings. Indeed it is irrelevant as to whether the users of the building are merely in the service industries and perform only office work or whether they also for example carry out their work in technical laboratories, or also other commercial or even industrial activities. Increasing numbers of electrical apparatus are installed which all inevitably produce heat These various heat-producers are copy apparatus, computers, and printers, fax apparatus, televisions, video means, telecommunication means, but also refrigerators, coffee machines, cleaning machines etc. Last but not least, each person present in the room is also a heat source due to his or her body temperature and contributes to the heat load. In the future therefore, on account of the building shells which are becoming thermally better insulated, and the internal heat loads due to the increased use of technical apparatus which have just been mentioned, it is therefore the cooling and not necessarily the heating of such buildings which will come to the forefront. The heat management is shifting in this direction also with regard to residential buildings.

The transport of heat away from the rooms may be effected in two different manners: Either the excess heat is transported away immediately or directly on its occurrence to a cooling system, or the excess heat is transported into an intermediate reservoir so that it may be exploited again at a later point in time when required, or is otherwise definitively led away to the surroundings outside the room being considered. The first variant requires water or another coolant which must be available for the time during which the heat occurs, e.g. during the working hours. A compression refrigerator may only mostly cool this during the hot part of the year. The second variant, that is to say the temporary intermediate storage of excess heat may be realised in various ways and offers the following possibilities: Firstly natural heat sinks may be used for leading away the heat, for example at night, to the cold air of the surroundings via a heat exchanger, whose temperature then of course increases again during the day, or however a permanent heat sink is created by way of an earth probe or earth piles, whose temperature always remains roughly the same and which when required may be used as a heat source, wherein specifically the groundwater serves as such a heat source and heat sink depending on whether one wishes to cool or to heat. It is the improved use of regenerative energy sources, which is at the forefront with the present invention, in that by way of the intermediate storage of heat, the time difference between the demand for regenerative energy and the supply is to be compensated. The use of a refrigerator may also be considered as a further possibility which is used for cooling the air during the day but is used for cooling the room at night. This variant also allows the peak cooling output of a refrigeration installation to be significantly reduced since the full cooling output does not need to be made available immediately, but may be distributed over a longer period of time, for example 24 hours, on account of the possibility of the intermediate storage. With new buildings, the building mass may be used as a thermal intermediate reservoir by way of pipes in the core of the building component, and may be economically managed in an optimal manner. This is hardly possible with conversions since the ceiling structure is already present and thus pipes may only be installed with an extraordinarily large expense. Furthermore in such rooms there are mostly suspended ceilings which on the one hand conceal the ceiling installations and on the other hand assume sound insulation functions. In order despite this, to be able to cool the room in an efficient manner, the existing double ceiling is replaced by a cooling ceiling.

Cooling ceilings which may be cooled with water are known. They consist essentially of sheetmetal plates, mostly of steel, stainless steel or aluminium which are assembled on heat conducting rails in the form of tube sections by way of a snap mechanism which have been previously installed on the ceiling by way of a mounting system. These tube sections are aluminium-extruded sections in which a copper pipe is pressed in a good heat-conducting manner. These tube sections are mounted on a cooling circuit and water may flow through these. After the assembly on a ceiling, these sections have limbs and feet projecting downwards which when sheetmetal plates have been attached from below, bear on the upper side of the plates in a flush manner and form a heat bridge. The for assembly are equipped on their upper side with a clamping section which may be clicked into spring-steel clips on the pipe section which are open to the bottom The sheetmetal plates may be coated or anodised or may be plastered or glued on the building (construction) site. For improved sound insulation, one has often used perforated sheetmetal plates with sound absorption material arranged behind this.

Cooling ceilings of modules capable of being folded away are also known. With these, the sheetmetal plates of steel, stainless steel or aluminium acting as cooling elements are equipped with cooling pipe systems which are assembled on these. These modules on one side are then pivotally articulated onto system sections which were previously assembled on the ceiling. After connecting the cooling pipe system to a cooling circuit, the modules may be pivoted up and secured in the horizontal position by way of a snap mechanism or by way of securing screws or securing pins.

A further known cooling ceiling system consists of individual smooth surfaced or perforated panels of aluminium sheet metal parts which are folded at the edges on all sides. In the folded edges, in the longitudinal direction of the edges, there are provided contact surfaces for zinc-coated pipe conduits which are fastened on the contact surfaces by way of steel clips. The pre-manufactured assembly units are fastened on the pipe ceiling with tie rods and when required may be equipped with acoustic plates at the top or on the lower side for achieving an improved sound insulation, which however reduces the cooling performance somewhat.

There are finally solutions with which a cooling pipe system is installed on a ceiling in that the cooling pipes from below are clicked into U-sections open at the bottom which were previously assembled on the ceiling. Then from below sheet metal panels filled with sound insulation material are suspended between the U-sections, and these panels on their lower side comprise a laterally projecting edge so that the cooling pipes and the assembly section are covered. A thermoactive ceiling element is known from JP 07 293908 A, which comprises a closed casing which for the intermediate storage of heat contains phase change material as a latent heat reservoir, wherein the heat exchange if effected via a heating and cooling tube. A microencapsulated phase change material is disclosed in U.S. Pat. No. 5,435,376 but however no thermoactive ceiling element. The thermoactive ceiling elements which have been known up to now, although functioning in principle, however have the deficiency that the heat exchange is effected far too sluggishly since the water carrying the heat only comes into contact with the phase change material at a small surface. Furthermore these ceiling elements are questionable with regard to fire technology when one considers the danger which paraffin entails. Finally the known thermoactive ceiling elements also lack measures for sound protection, although they indeed act in a sound-reflecting manner.

The disadvantage with all these known systems is the fact that their heat capacity is relatively low and thus the heat may not be intermediately stored during the cooling, but must be led away directly to the coolant. In other words: these ceiling elements serve merely to accommodate the heat in an efficient manner and lead to it directly to the cooling pipe system, but not however to temporarily intermediately store the heat.

It is therefore the object of the present invention to specify a thermoactive wall and ceiling element for heating and cooling rooms in newly built and old buildings, including lightweight construction buildings, which overcomes all those disadvantages mentioned above. In particular it should not only permit the direct leading away of heat from the room but also permit it to be temporarily intermediately stored so that the heat may flow away to the surroundings which later have become colder, such as the surrounding air which at night acts as a natural heat sink, with a time delay with respect to the accumulation of heat. The stored heat may also be used again if required. Furthermore this thermoactive wall and ceiling element is to have a small construction height, is to be economical in manufacture and is should be able to be very easily installed in the building. It is to be able to be used in a comprehensive manner and should be able to be incorporated into old buildings as well as new buildings in a manner being compatible with their architectural concept. If necessary it should also have good sound insulation properties. Furthermore, in a particular embodiment, it should fulfil fire safety standards such that it meets the fire safety regulations set by the authorities.

This object is achieved by a thermoactive wall or ceiling element for construction (installation) in rooms of newly built and old buildings, including lightweight construction buildings, in that it comprises a closed casing which contains a phase change material as a latent heat reservoir for intermediately storing heat, as well as at least one associated heating and cooling pipe for controlling the heat exchange between the casing and its surroundings, wherein the casing for intermediately storing heat contains a phase change material which is based on normal paraffin or a salt hydrate and for increasing the thermal conductivity in the region of the phase change material, in its inside, is either equipped with heat conducting ribs and/or graphite is added to the phase change material, for increasing the heat conduction capability, and which is characterised in that in the inside of the casing heat-conducting ribs are arranged in heat-conducting contact with the casing, between which the heating and cooling pipes (tubes) of a capillary tube mat extend, whose connections are led through the lid of the casing for insert (plug-in) connections, and that the remaining inside of the casing of cast out (filled) with a plaster as a carrier mass in which phase change material encapsulated in plastic capsules is dispersed, as well as that a viewed ceiling element is arranged on the lower side of the casing.

Advantageous embodiment of this thermoactive wall and sealing element are to be deduced from the dependent patent claims. Various variants of this thermoactive wall and ceiling element are presented by way of the drawings, and these are described in detail and their function explained in the subsequent description.

There are shown in:

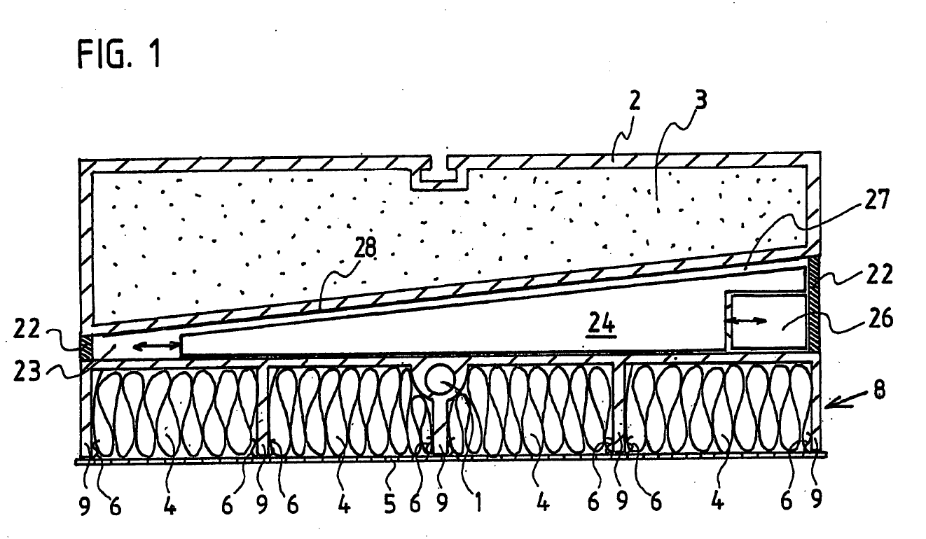

FIG. 1 a first variant of a thermoactive wall and ceiling element shown in a cross section, with which the heating and cooling pipe runs outside the casing in a lamellar design which is filled with sound absorption material and carries the ceiling sheet [metal] (plate), wherein this lamellar design is interruptibly heat-conductively connected to the casing;

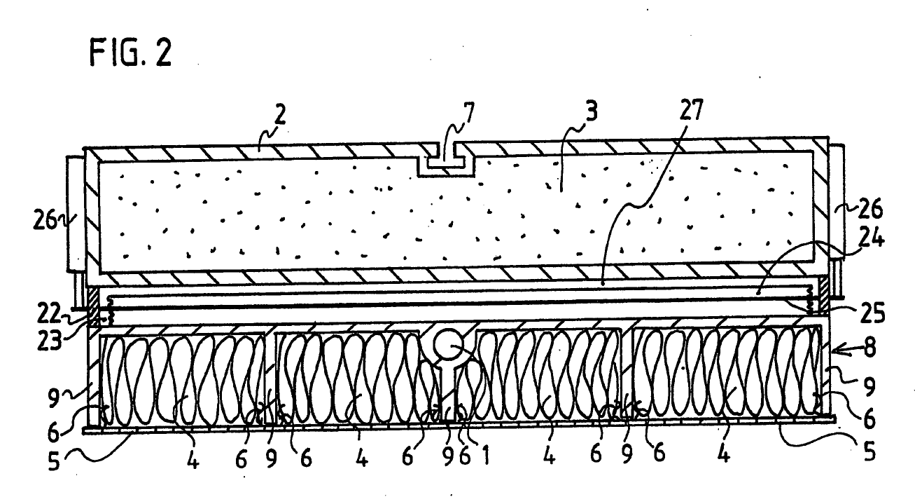

FIG. 2 a second variant of a thermoactive wall and ceiling element shown in a cross section, with which the heating and cooling pipe run outside the casing in a lamellar design which is filled with sound absorption material and carries the ceiling sheet [metal] (plate), wherein this lamellar design is interruptibly heat-conductively connected to the casing;

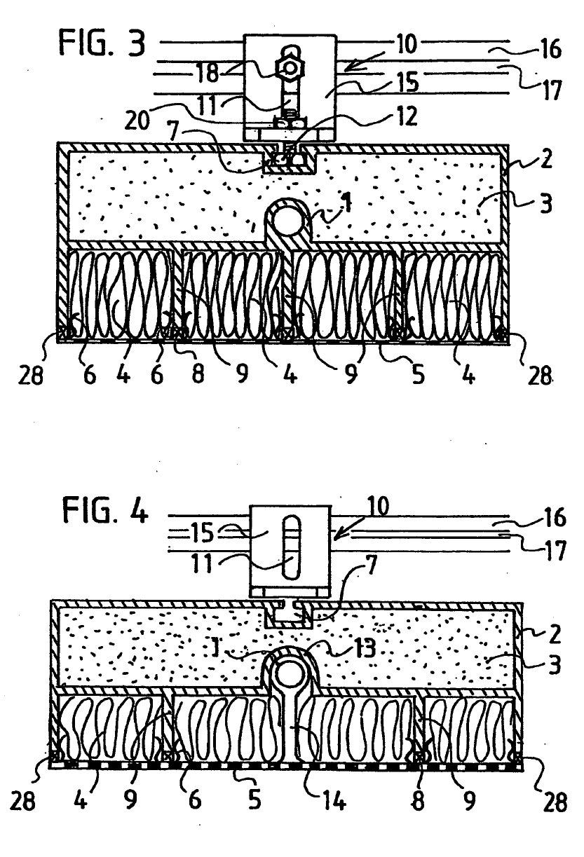

FIG. 3 a third variant of a thermoactive wall and ceiling element shown in cross section, with which the healing and cooling tube is integrated into the casing material and runs in the inside of the casing, and which on the room side is equipped with sound absorption material;

FIG. 4 a fourth variant of a thermoactive wall and ceiling elements shown in a cross section, which on the room side is equipped with sound absorption elements and with which the heating and cooling pipe runs in a heat-conducting manner in a channel in the lower side of the casing along its outer side and is connected in a heat conducting manner to the ceiling sheet [metal] (plate) on the room side;

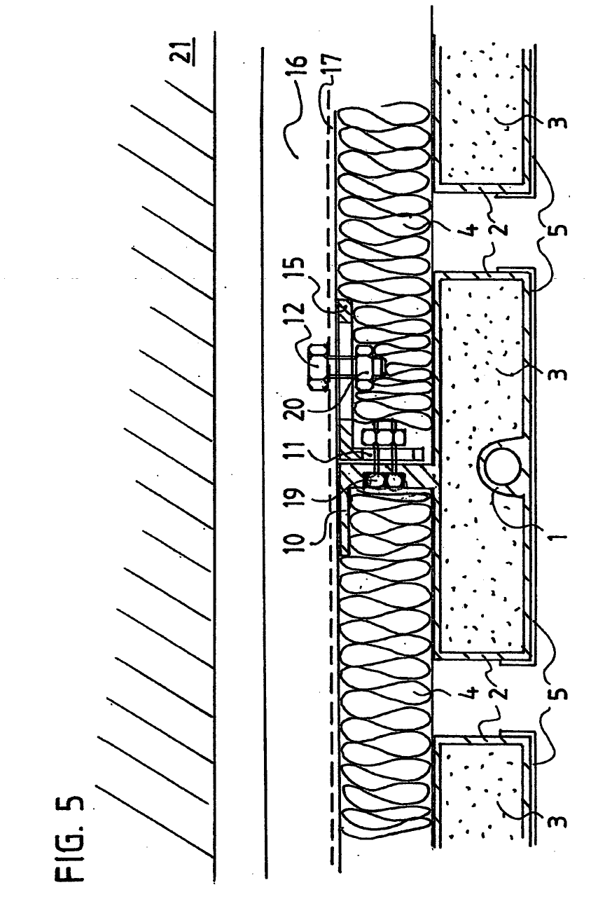

FIG. 5 a fifth variant of a thermoactive wall and ceiling element shown in a cross section, with which the heating and cooling pipe is integrated in the casing material and the sound insulation material is arranged above the casing;

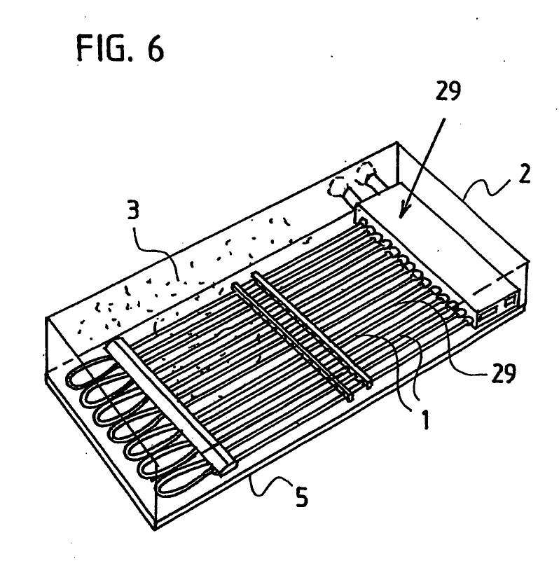

FIG. 6 a sixth variant of a thermoactive wall and ceiling element shown in a perspective view, with which the heating and cooling pipes are formed by a capillary tube mat which is integrated into the casing material;

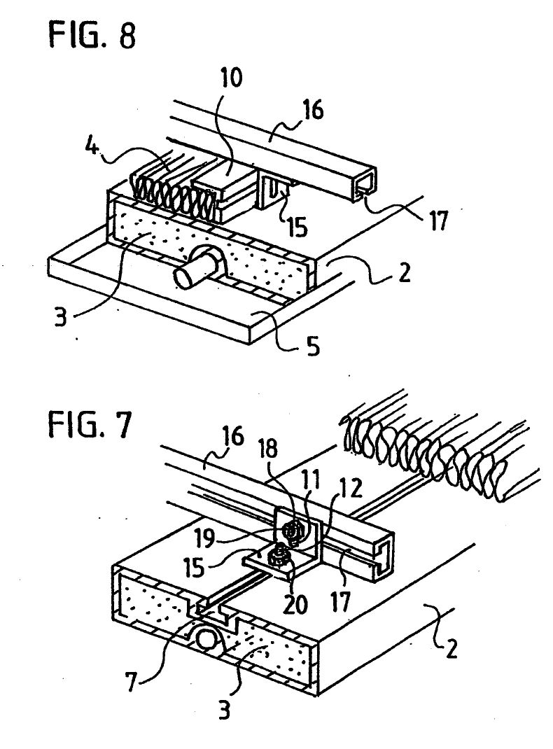

FIG. 7 a first variant of a mounting device for such wall and ceiling elements;

FIG. 8 a second variant of a mounting device for such wall and ceiling elements;

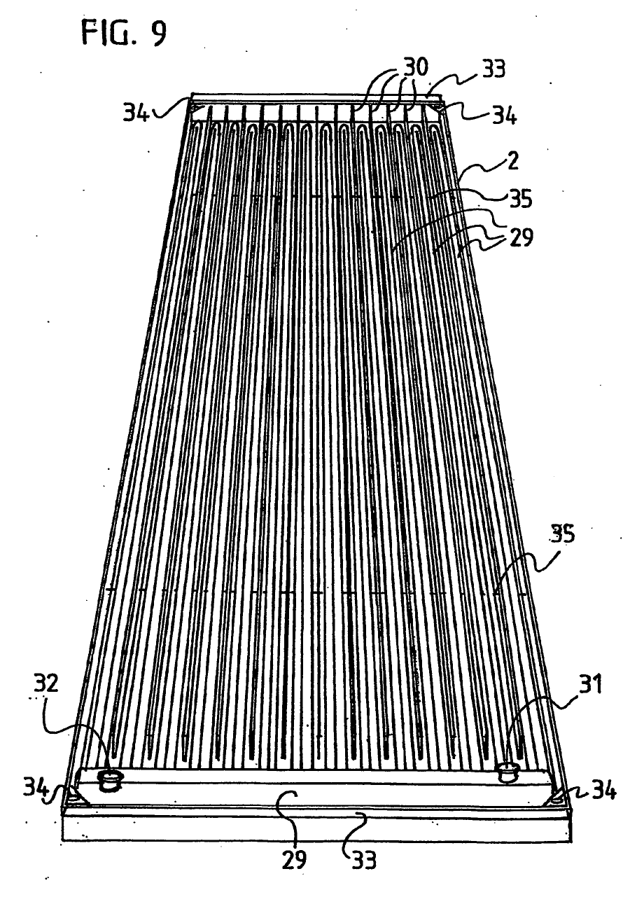

FIG. 9 a seventh variant of a particularly fireproof thermoactive wall and ceiling element shown in a perspective view, with which the heating and cooling pipes are formed by a capillary tube mat with microencapsulated PCM dispersed in plaster.

The thermoactive wall and ceiling element is firstly described by way of FIG. 1. It consists essentially of a closed casing 2 of heat-conducting material which is filled with a phase change material 3, as well as of a lamellar design 8 with a heating and cooling pipe 1 and with a viewed ceiling element 5, wherein all these elements are actively connected to one another with regard to heat technology, as well be explained later. In the shown example, with regard to the casing 2 it is the case of a sheet [metal] section with a lower side which seen in cross section runs to the upper side in an oblique manner, wherein this sheet [metal] section encloses a cavity in that it is closed in a fluid-tight manner to the front and rear with a lid (cover) in a fitting manner. This sheet [metal] casing 2 is advantageously manufactured of aluminium for reasons of weight, even if steel sheet metal, chrome steel or other nonferrous metals are considered as a manufacturing material. The casing 2 may also be manufactured of a suitable plastic which with a low wall thickness is likewise good at conducting heat. The phase change material 3 is either used in it pure form or is included in a carrier material. The sheet [metal] casing may contain a separate supply and discharge connection so that the phase change material 3 may be filled later in a liquid form or may also be removed again so that an later retreat working may be accomplished in a simple manner. Here a lamellar design 8 is constructed below the casing 2 and this design forms a number of rib-like lamellae 9 between which a sound-absorbing material 4 is accommodated. This lamellar design 8 is fastened peripherally to the body 2 via side-walls 22 which are manufactured of good heat-insulating material and thus act as thermal separation walls 22. Thus a cavity 23 is formed between the casing 2 and the lamella design 8, within which a good heat-conducting heat contact body 24 wedge shaped in cross section is installed. Here, this lies on the upper side of the lamellar design 8 in a displaceable manner and is connected to this design in a heat-conducting manner. This wedge-shaped heat contact body 24 for example is an aluminium solid material body or it consists of an aluminium sheet [metal] hollow body which is filled with a good heat conducting metal wool or a metal foam filling. On the higher side of its wedge shape there are arranged drive means 26 by way of which the heat contact body 24 in the cavity 23 may be horizontally displaced to and fro. If in the picture it is displaced completely to the left then a heat-conducting connection of its upper side to the lower side of the casing 2 which is provided with a contact layer 28 is effected, and thus depending on the prevailing temperature gradient at this moment, heat may flow to and fro between the casing 2 and the lamellar design 8 and the viewed ceiling element 5 fastened thereon, which for example may be a perforated sheet [metal] (plate). If however the heat contact body 24 is displaced completely to the right as is shown in the picture, then an air gap 25 arises above it which thermally separates it from the casing 2. The thermal separation may be encouraged by a low-ε-coating of the lower side of the casing and the upper side of the heat contact body 24 for reducing the heat radiation in the long-waved region.

The drive means 26 advantageously consist of one or more electrochemical actuators. With such an electrochemical actuator, amongst other things known under the initials ECA, it is the case on the one hand of the combination of an expansion element as pneumatic components and on the other hand of a battery as an electrochemical component for producing gas in a controlled manner. The battery with nickel hydrogen cells, by way of the supply and discharge of constant current at a low voltage of approx. 2 Volts may reversibly produce and consume hydrogen which then feeds an expansion element in the form of a metal bellows. Such ECAs are very suitable as regulation elements and specifically as positioning means since they are characterised by good control properties and with small construction sizes may muster large forces with a low energy consumption, and to top it all they function completely without noise. In comparison to motor drives, they require no peripheral equipment since the necessity of having to convert a rotational movement into a translatory movement does not exist. Holding conditions may be used in every position of the regulation path. The supply of low charges leads to very small regulation movements which can be detected by a path sensor. The regulation speeds without load are approx. 0.1 mm/s to 1 mm/s and the typical inner pressures of ECAs lie in the region of 4 bar to 50 bar. Electroactive polymers are suitable as further drive variants, which on application of an electrical field undergo a length extension, or also electroreological fluids or hydraulic or magnetic force cylinders may be suitable as drive means.

At least one heating and cooling pipe 1 runs in the inside of the lamellar design 8 which advantageously consists of a section manufactured with the continuous casting method. This heating and cooling tube 1 serves for the management (running) of the complete thermoactive wall and ceiling element. The flow channels of several individual wall and ceiling elements, said flow channels being formed by the heating and cooling pipes 1, are connected to one another on assembly, such as by way of soldering or by way of pipe bows (bends) capable of being coupled, or flexible tubing connections. A single such wall and ceiling element given a defined section width is advantageously manufactured in defined system lengths; for example 1 m, 2 m and 3 m length The section width is limited by the maximal assembly weight. The lengths are determined such that the peripheral extent of the element still remains manageable and they may be easily carried around on the building site and installed by two fitters.

A second variant of a thermoactive ceiling and wall element is shown in FIG. 2 which with many parts is constructed identically to that of FIG. 1, specifically likewise with a casing 2 which is filled with a phase change material 3 as well as with a lamellar design 8 which is thermally separated from the casing 2 and which is connected to the casing 2 via side walls 22 of good heat-insulating material running in a peripheral manner. The lamellar design 8 is closed with a viewed ceiling element 5 and accommodates a sound-absorption material 4 between its lamellae 9. In contrast to the design according to FIG. 1, here the control of the heat flow between the casing 2 and the lamellar design 8 is solved in a different manner. Here, a good thermally conductive and elastically compressible heat contact body 24 is installed in the cavity 23 between the casing 2 and the lamellar design 8. This for example consists of a suitable heat conducting polymer. A movement sheet [metal] (plate) 25 runs within this body 24 or on its upper side, and may be moved upwards or downwards in a parallel manner and at the same time moves the heat contact body 24 with it. If the movement sheet [metal] (plate) 25 which in the example shown here runs within the heat contact body 24 is brought into its uppermost position, then the heat contact body 24 connects to the lower outer side of the casing 2 and a heat-conducting connection to this is effected. If however the movement sheet [metal] (plate) 25 is brought into its lowermost position, then the heat contact body 24 is compressed and an air gap arises between its upper side and the lower side of the casing 2. This air gap acts in a thermally insulating manner so that the lamella design 8 to a great extent is thermally separated from the casing 2. The compression and expansion of the heat contact body 24 in the shown example is solved by way of this movement sheet [metal] (plate) 25 which for its part is accomplished by thermoelectric drive means 26, electric motors, hydraulically or magnetic force cylinders but also electrochemical actuators ECA or electroactive polymers (EAP) which as shown here are fastened to the outer side of the casing 2.

The appropriately required thermal separation of the casing 2 from the lamellar design 8 with the viewed ceiling element 5 fastened on the lower side of this lamellar design may also be realised with further design variants. For example a number of good thermally conductive material bridges may be provided in the cavity 23 between the casing 2 and the lamellar design 8 which may then be interrupted similar to electronic switches, wherein this interruption and closure may be effected in an electrical manner. In a further variant, electroactive polymers EAP may be used as a drive means for the deformation of the elastically compressible heat contact body, and these may be arranged in the inside of the heat contact body 24. They are electrically actuated and expand when supplied with current and contract again when the current is led away so that when required an air gap may be produced between the heat contact body 24 and the casing 2.

As already mentioned, a phase change material 3 is located in the inside of the casing 2 which forms an essential component of these ceiling and wall elements. Such materials have a particularly high melt enthalpy and are known as PCMs, which is an abbreviation for phase change material. They preferably comprise paraffis. Paraffin is a collective term for saturated hydrocarbon mixtures which are mainly extracted from crude oil, are a by-product of lubrication oil manufacture, and are also called waxes. They are organic substances which after refining are odourless, tasteless and non-toxic. Paraffins are substances which are suitable for thermal applications on account of favourable chemical and physical properties. Their technical handling is not a problem. One differentiates between normal paraffins and iso-paraffins. Normal paraffins consist of simple, long-chain molecules. Iso paraffins in contrast have molecules with a long basic chain and branches branching from this. Normal paraffins are used for applications with regard to thermal technology as are present here. The chemical total formula for paraffin is CₙH₂ₙ₊₂. For paraffins with a melting temperature between 20° C. to 90° C., the number n lies between 17 and 50. The melting temperature of the material increases with an increasing molecular chain length or increasing molar mass. PCMs may be conditioned to the desired melting temperatures in accordance with the desired application. The phase change material based on paraffin used here, apart from a high specific heat capacity has a melting temperature of 20° C. to 24° C. which corresponds to usual room surface temperatures. Ideally the phase change material at a melting temperature of approx. 22.5°C. should have a specific heat capacity of at least 35 kJ/(kg K). The specific heat capacity at 21° C. or 24° C. should amount to at least 55% of the maximal value of the complete PCM filling given a substance density of 900 kg/m³ (PCM graphite mixture). Apart from the sensitive, thus perceivable heat which such a material releases, also in particular the latent heat which has been stored during the melting phase is again released during the solidification phase. The liquefaction as well as the solidification is effected in a restricted temperature range for example within 4-5K. If other room temperatures are to be maintained, which differ greatly from those which are common, then a suitable phase change material with suitable characteristics is selected. The particular advantage of a PCM lies in the exploitation of the latent heat during the phase change. Salt hydrates also act as a phase change material, such as sodium acetate trihydrate or sodium sulphate (mirabilite).

In order to efficiently exploit the advantages of a PCM, a high melt enthalpy of the elements with a simultaneously narrow melt band should be ensured. The specific heat capacity of thermal paraffins in the solid as well as liquid condition is roughly 2.1 kJ/(kg.K). Very good heat storage properties result together with the melt enthalpy of 180 to 230 kJ/kg of pure paraffin and that of 140 to 160 kJ/kg with a graphite-paraffin composite. Usually a high thermal conductivity is required for charging and discharging a latent heat reservoir. Thermal paraffins, as almost all organic substances however have a relatively low thermal conductivity of only approx. 0.18 W/(m.K). This disadvantage is counteracted by way of adding graphite to the PCM. This measure considerably increases the thermal conductivity. Although PCMs have a thermal conductivity which is about ten times worse that concrete, then with the addition of graphite of 100 to 150 kg per m³ of PCM, the thermal conductivity becomes about three times better than that of concrete. In order to increase the fire resistance of the elements and to avoid the exit of paraffin, the phase change material may be used in an encapsulated form, that is to say in suitable capsules whose wall thickness and volume are adapted to the requiremerts. A special case of such an encapsulation is microencapsulating For this, the used paraffins are enclosed in so-called microcapsules. Here it is the case of plastic capsules with diameters between 5×10⁻⁶ m and 2×10⁻⁵ m. The melted paraffin is firstly distributed in a fine manner by way of stirring it in water. With this, tiny paraffin droplets are formed, depending on the stirring speed and other parameters. The solid, very thin wall of the microcapsule is produced around each one of these individual droplets in a so-called in-situ synthesis from plastic precursors. The microencapsuled paraffin may then be applied into different commercially widespread building materials in the manner of a powder, for example in the inner plaster or filling masses. For its incorporation into a thermoactive wall or ceiling element, the microcapsules filled with paraffin are stirred into a plaster mass and finely dispersed therein, so that they make up about 30% to 50% of the mass share of the total end mass. This mass, with a maximal thermal capacity of about 10 kJ/(kg K), is then inserted in such a wall or ceiling element as the effective thermoactive element. The encapsulation of the PCM and the dispersion in a curing mass ensures that the paraffin may not exit. On account of the small size of the capsules, the total surface of the PCMs or paraffins is very large. The microencapsulation therefore effects an optimal heat exchange between the PCM and the building material.

For encouraging a reliable heat exchange, the wall and ceiling elements are designed such that larger surfaces are created in relation to the contained PCM mass. This is achieved with a relatively low plank-like casing 2. Furthermore one may also arrange heat-conducting ribs in the inside of the casing 2 so that in total an improved heat conductivity results for the room which contains the phase change material 3. An expansion volume for unbonded PCM must always be provided in this closed casing 2 in order to reduce excess pressure. The density of liquid paraffins lies between 750 and 850 kg/m³ depending on the melting temperature. Solid paraffins however have a density of 800 to 900 kg/m³. With a solid-to-liquid phase change, a maximal volume expansion of 10% results from this. One speaks of an undercooling of a phase change material if its solidification temperature lies below the melting temperature. At the same time however an undercooling in practise does not exist with a normal paraffin PCM—at least in comparison to other latent heat storage materials. A PCM during its lifetime or application may undergo very many heating and cooling cycles. For this, thermal paraffins in contrast to many other PCMs are not very sensitive to ageing and they are stable with regard to their cycle since no chemical reactions occur during the storage operation in the storage material or with respect to heat transport means and installation materials. Thermal paraffins are specifically inert with respect to almost all materials. Their very name describes their nature: “parum afinis” which means they exhibit hardly any chemical reactions. Indeed the melting and solidification of the paraffins is rather a purely physical procedure. For this reason the heat storage capacity remains at a constant level during the complete lifetime. Thermal paraffins are thermally stable up to 250° depending on the melting temperature. Paraffins do not boil even at higher operating temperatures, i.e. no high vapour pressures arise. In the liquid condition, the viscosity is similar to that of water. Paraffin or wax is combustible, but the combustion temperature lies significantly above 250°. Thermal paraffins are completely ecologically safe substances. They neither endanger water nor are they toxic or harmful to health. They may however be recycled and are biologically degradable.

If we now consider the initial condition of a wall and ceiling element installed in a room in the morning of a hot summers day. The phase change material in the casing 2 is solidified and the complete thermoactive element is at a temperature of 21° C. for example. The thermal connection between the viewed ceiling element 5, that is to say the viewed ceiling sheet [metal] (plate), and the casing 2, is ensured by the heat contact body 24. If the room temperature increases only a little then heat begins to flow through the viewed ceiling element 5 and the heat contact body 24 into the casing 2 and here the phase change material 3 begins to slowly liquefy. Thus heat is extracted from the room without any cooling output which consumes energy becoming necessary. The absorbed heat is simply stored in the phase change material of the casing 2. In this manner, at night, stored heat may be led away to a natural heat sink, by which means the phase change material 3 is again solidified and is ready to take up heat again during the coming day. If one can foresee that a significant cold front is coming, then one does away with the leading-away of heat. The same applies to the case that during the night the temperature in the room is reduced to such an extent that the room is considered to be too cold to pleasantly work in. In this case the heat from the casing is delivered to the room again in the reverse direction via the viewed ceiling element 5. In this manner the room temperature may be maintained during the day to within narrow limits without any energy expense. Additional heat may be supplied or led away by way of the heating and cooling pipe 1, according to requirements, for encouraging the heat exchange with the room or for activating a heat flow between the room and the phase change material 3. If the temperature of the outer surroundings which reduces during the night is not sufficient to cause the liquefied phase change material to solidify until the following morning, then one may aid this with cooling water from a natural heat sink, which for this purpose circulates through the heating and cooling pipe 1. Completely independently of the function of the phase change material, with regard to the heating and cooling pipe 1, when required one may of course supply heat to the room from a heat source or lead away heat from the room to a heat sink. The lamellar design 8 is thermally separated from the casing 2 for such a direct cooling and heating. The casing 2 with the phase change material acts as much as possible as a heat reservoir and helps to dispense or take up heat shifted in phase with regard to the temperature course over 24 hours.

FIG. 3 shows a third variant of the thermoactive wall and ceiling element. Here it is shown in cross section. In the inside of the casing 2 the heating and cooling pipe 1 is formed running along the lower side of the casing out of the casing material as a flow path in the longitudinal direction of the casing 2 or of the section. This heating and cooling pipe 1 is therefore connected to the casing 2 in a stationary manner and directly belongs to this casing. It therefore consists of the same material as the casing and when required may have an insert pipe of copper. On the lower side of the casing 2, lamellae 9 are arranged in the longitudinal direction of the casing, between which a sound absorption material 4 is inserted for improving the acoustics of the room. The complete design shown here is closed from the bottom by way of a perforated ceiling sheet [metal] (plate) as a viewed ceiling element 5. This viewed ceiling element 5 is stuck onto the lower edge sections of the lamellae 9 by way of a claiming mechanism of spring-steel clips 6. Furthermore a contact layer 28 is deposited onto the lower edges of the lamellae 9, which contributes to an improved heat-conducting connection of the connection since indeed heat is significantly taken up from the room via the perforated ceiling sheet [metal] (plate) and when heating is required, this heat is dispensed again to this. With regard to this contact layer 28, it may be the case of a thermally conductive foam material which may be compressed. The passage of heat is sufficiently large even with a very moderate thermally conductive properties, on account of the low thickness of the material. A fundamentally good heat transfer from the ceiling sheet [metal] (plate) or from the viewed ceiling element 5 to the lamellae 9 on the lower side of the casing is decisive. In one variant, steel wool may take the place of the sound absorption material which likewise has a sound-absorbing effect even if very low, but is also a good heat conductor. In this case the lamellae 9 are superfluous and the viewed ceiling element 5 is merely fastened to the edge of the casings. A groove 7 which is T-shaped in cross section is arranged on the upper side of the casing 2 with which the casing 2 by way of angle sections may be fastened to an associated support design in the form of a square tube 16 with a longitudinal slot 17. The angle sections 15 are fastened on the groove 7 with screws, wherein the heads of the screws 12 are seated in the groove 7 secure against rotation. The lateral elongate holes 11 on the angle sections permit the height or the distance of the casing 2 to the ceiling to be adapted and to compensate any irregularities. The angle sections 15 are mounted onto a square tube 16 with a central longitudinal slot 17, said tube on the building side being pre-assembled on the ceiling, as this is shown in FIG. 3. A ceiling element in this case is fastened transversely to its longitudinal direction on at least two such square tubes 16 arranged in a parallel manner.

A fourth variant of a thermoactive wall and ceiling element is shown in cross section in FIG. 4 which likewise is equipped with sound-absorption material 4 on the room side. The heating and cooling pipe 1 here is not directly outwardly formed from the material of the casing but runs within a channel 13 in the lower side of this casing 2 in a heat-conducting manner, and this channel extends along the casing 2. The casing 2 on its lower side likewise comprises lamellae 9 projecting downwards between which a sound-insulating material 4 is laid. In one variant, again steel wool may be used for the sound absorption material 4. In this case the lamellae are superfluous and the perforated ceiling plate as a viewed ceiling element 5 is merely fastened to the edges of the casing. The actual heating and cooling pipe 1 is fastened on the perforated ceiling sheet [metal] (plate) in a heat-conducting manner via a support web 14. Here it may be the case of a steel or aluminium tube 1 which when required may also be equipped with an insert tube of copper. The lower edge of the support web 14 is soldered, welded or bonded onto the perforated ceiling sheet [metal] (plate) or viewed ceiling element 5, by which means a heat bridge to the viewed ceiling element 5 is created. The viewed ceiling element 5 together with the heating and cooling pipe 1 is stuck onto the casing 2 from below, by which means a heat-conducting connection between the pipe 1 and the channel 13 in the casing 2 arises. At the same time the viewed ceiling element 5 may be provided with spring steel clips 6 by way of which it may be simply fastened to the lamellae 9 of the casing 2 by clipping on, after the pipe 1 of the individual wall and ceiling elements have been connected to one another by way of soldering or by way of tube bends capable of being coupled, or flexible tubing connections. If required, the viewed ceiling elements 5 may thus be easily removed. A groove 7 is admitted on the upper side of the casing 2, with which the ceiling element may be fastened to a support. design 16 which fits with this, as has already been described with regard to FIG. 3. This variant of the wall and ceiling element is also suitable for retrofitting a cooling ceiling which already has a viewed ceiling plate as well as a cooling tube which is connected to the viewed ceiling plate in a heat conducting manner. In this case one merely changes the construction above the cooling tube. A casing 2 with phase change material 3 is installed above each cooling tube. The casing 2 on its lower side comprises a channel in which the already present cooling tube comes to lie in a heat-conducting manner, wherein the perforated viewed ceiling may otherwise be further made use of. This thermoactive wall and ceiling element may furthermore be also installed onto walls in the same manner as onto room ceilings.

Yet a fifth variant of,the thermoactive wall and ceiling element is shown in cross section in FIG. 5. With this variant the heating and cooling pipe 1 is integrated in section material and as a peculiarity the sound absorption material 4 is arranged above the casing 2. With this embodiment, the heat conducting lamellae between the lower side of the casing 2 and the ceiling sheet [metal] plate 5 which is not perforated in this case are done away with. The viewed ceiling element 5 in one variant may also be formed by a layer of plaster or a plaster plate. Pipes arranged with a material fit with the casing may take the place of a heating and cooling pipe 1. Such ceiling elements with which the sound absorption material 4 is arranged above the casing 2 are laid such that in each case a gap is set free (created) between the individually assembled ceiling elements so that the sound impinges the sound absorption material 4 arranged above the ceiling elements, through these gaps, and is absorbed by this material. If in contrast one completely does away with the sound absorption capability and leaves out the sound absorption material, one may then make do without any distance between the elements and the insulation layer. This variant is then particularly suitable for wall installation.

A variant is shown in FIG. 6, with which the heating and cooling pipe 1 run within the casing 1 and are formed by a commercially available capillary tube mat 29. Such capillary tube mats may be fabricated in any lengths or widths are for example are layered into the casing 2 in the longitudinal direction, whereupon the phase change material 3 is filled which then encloses the tubes of the capillary tube mat 29.

The wall and ceiling elements may be intalled as shown in FIG. 3 and 7 if they comprise a groove 7 with a T-shaped cross section on their upper side. A hexagonal screw head of a screw 12 fits into this groove 7 so that the screw 12 projects upwards out of the groove 7 and is held in it in a rotationally secure manner, but displaceable along the groove 7. The horizontal limb of the angle section 15 is pushed over the screw 12 and is secured with a nut 20 which belongs to the screw. The limb of the angle section 15 projecting upwards comprises a vertical elongate hole 11 which is passed through by a screw 18 whose hexagonal head fits into a square section 16 with a lateral longitudinal slot 17 in a manner secure against rotation, so that it is rotatably held therein. Thus the angle section 15 may be displaced along the square section 16 and may be adjusted in height by the length of the elongate hole 11. For fastening, one yet only needs to tighten the nut 19 belonging to the screw 18. The square section 16 by way of anchor bolts is previously assembled onto a ceiling to be equipped. Thus the ceiling element may be displaceably aligned and fastened in two directions on this square section 16.

The wall and ceiling elements on their upper side, instead of a groove 7 may comprise an upwardly projecting angle section 10 as is to be deduced from FIG. 5 and is shown perspectively in FIG. 8. The wall and ceiling element may be furnished with sound absorption material on both sides of the angle section. An angle section 15 is screwed onto this angle section 10, and this piece in each limb comprises a vertically running elongate hole 11. The angle section 10 on the upper side of the casing 2 comprises such a groove which accommodates a screw head in a rotationally secure manner, wherein however the screw remains displaceable along the groove. The horizontal limb of the angle sections 15 is fastened on the lower side of a square tube 16 which comprises a longitudinal slot 17 on this lower side and was previously assembled onto the raw ceiling. The longitudinal slot 17 allows a screw with its head to be inserted into the square tube 16 so that the screw head 12 is held therein secure against rotation, whilst the screw projects downwards through the longitudinal slot 17 and is displaceable along the square tube 16.

A particular embodiment of the thermoactive wall and ceiling element is shown in FIG. 9. The edge regions of the casing 2 are raised and are sealingly closed at the corners. Here one sees the casing 2 without a lid, and the heat conducting ribs 30 which run therein in the longitudinal direction and which are connected along their lower side to the base plate of the casing 2 in a heat-conducting manner. With this it may be the case of aluminium angle sections which with transverse struts 35 form a grid. The lower, horizontally running limb of the sections by way of a special adhesive tape are the bonded to the base plate of the casing in a heat-conducting manner. These heat conducting ribs 30 are distanced to one another by approx. 30 mm and the conduit loops 29 of the capillary mat 29 run between them. At least one individual conduit loop 29 runs in each case between two heat conducting ribs 30. For this the capillary mat 29 may merely be inserted into the casing 2 which is still open at the top so that the wall and ceiling element is in the condition shown here. On the capillary mat 29 one may recognise the upwardly directed supply union 31 and the oppositely lying discharge union 2. The casing 2 is then filled with a pasty caster mass, wherein approx. 30% to 50% of its mass consists of microencapsulated phase change material. With this the material is finely distributed over the whole contents of the casing. After filling the casing, the mass is scraped flat and then cures. At the end, the element is closed at the top with a lid (cover) of zinked sheet metal of approx. 0.75 mm thickness and is riveted at the edges. At the rear, the edge region is folded off to the outside so that a mounting fold is formed here which permits the simple installation of the element to a ceiling. The installation is accomplished as follows: a flexible tubing conduit is connected to the unions 31, 32 by way of a plug connection. Subsequently the element with its rear fold-up is suspended on an assembly strip on the ceiling and afterwards the front corners of the casing 2 are pivoted up by way of a pull cable and fastened. The fastening angles 34 at the same time serve for suspending the pull cable and for fastening the casing 2 to the ceiling.

Irrespective of how these wall and ceiling elements are designed, in each embodiment they may be treated with special commercially available fireproof materials for increasing their resistance to fire. Thus for example a fire protection coating which given the effect of fire and heat forms a heat-insulating insulation layer is suitable. The casing may also be coated with a fireproof gel for example of a water-containing alkali silicate with a weight ratio of SiO₂ to Na₂O of 2.7-3.5 and glycerine content of 5-15% by weight. Furthermore fire-retarding polyolefins for example from the product series Exolit® from Claraint GmbH in D-65840 Sulzbach is also suitable for coating the casings. As one variant, the complete mass of the carrier mass and the encapsulated phase change material may be intermixed with a fire-retardant substance or with filler of a high heat thermal capacity acting as a heat sink. Additionally, in the case of a fire, the cooling of the ceiling elements either with the integrated pipe system or with an external water system, for example with a sprinkler installation are considered, which is in heat conducting contact with the ceiling elements or may be brought into contact with them. This has the advantage that whole walls and ceilings may be effectively cooled in the case of fire.

The basic concept behind all these thermoactive wall and ceiling elements is to permit a heat exchange between the room and the heat exchange material 3 which is provided, in order to be able to lead away the heat with a time delay to a natural heat sink which is later available as a result of temperature fluctuations, or if required to be able to use this heat again. This heat exchange of course makes sense above all between cool and hot time phases, thus between day and night or at times of rapid hot and cold incursions with a rapid reversal. If for example heat is supplied to a room during the day as a result of the radiation from the sun, the use of various electrical apparatus as well as the presence of many persons in the room, then one must cool this room in order not to allow this temperature to increase beyond a comfortable range. Now a highly efficient heat exchanger mass is created with the thermoactive wall and ceiling elements which has otherwise been lacking. On account of the low melting temperature of 22.5° C. of the specially conditioned PCM, the heat led through the cooling ceiling to a great extent is stored in the heat reservoir of the wall and ceiling elements by way of causing the PCM to melt. This procedure last for several hours until the PCM is completely liquefied. If heat is to be continued to be led away, then this is dispensed to an external heat sink. If a cold front unexpectedly occurs and the room temperature threatens to sink, the flow of heat is reversed. The PCM specifically begins to solidify with a slight drop in temperature whilst giving off its latent heat to the room via the viewed ceiling elements 5 which then act as a heat cover. The process of solidification also occurs when water circulates through the pipe 1 and removes latent heat from the PCM. Thus basically the heat which is removed from the room by cooling is stored in the wall and ceiling elements and may either later be dispensed to a natural heat sink outside the room or may be dispensed to the room again. Since the heat exchange is effected in a slow manner and lasts for several hours, it is predestined for the intermediate storage of heat between day and night or between office work and idle times.

Agilely acting designs of these thermoactive wall and ceiling elements help with extreme fluctuations of temperature caused by the weather or with large changes of the heat loads in the course of the day. Specifically, with those embodiments where the heating and cooling pipe 1 is not connected to the casing 2 or is not outwardly formed by it as one piece, one may provide a movement mechanism in order to temporarily decouple the rib system 9 with the viewed ceiling element 5 from the casing 2 which indeed contains the heat storage element in the form of the phase change material 3. This may effected either electromechanically, thermoelectrically, electrochemically, by way of an electrical field or hydraulically. The drive means may include electric motors, magnetic force cylinders, electrochemical actuators ECA, electroactive polymers EAP, hydraulic force cylinders or a motor-driven pull cable. By way of displacing the rib system 9 by a few mm downwards or lifting a heat contact body 24 from the casing 2, the material fit with the phase change material 3 is interrupted and the heat transport is greatly limited. In this decoupled condition the room may be supplied with large quantities of heat by way of the heating and cooling pipes 1 and the viewed ceiling elements 5, or reversely, large quantities of heat may be led away from the room so that a great heating and cooling output is available when required. If one heats in a high-output manner, then the heat via the viewed ceiling elements 5 directly reaches the room and only a very small share flows into the phase change material 3. Reversely, if one greatly cools then heat flows from the room into the viewed ceiling elements 5 and is transported away via the cooling pipes 1 without it being stored in the phase change material. By way of this decoupling of the storage layer, that is to say the casing 2 filled with PCM, from the actual heating and cooling elements, specifically the viewed ceiling elements which face the room, the system becomes thermally agile and by way of this behaves similar to a conventional cooling cover. In a room whose ceiling or walls are completely or partly lined with such thermoactive wall and ceiling elements, one may rapidly change the temperature to any value by way of the direct cooling and heating. An individual regulation of the room becomes possible by way of this.

List of Reference Numerals

1 heating and cooling tube
2 sheet [metal] casing
3 phase change material PCM
4 sound absorption material
5 view ceiling element
6 spring steel clips
7 T-shaped groove on the upper side of the sheet metal casing 2
8 lamellar design
9 lamellae on the lower side of the sheet metal casing
10 support design
11 elongate holes on the support design
12 vertical screw on the angle section 15
13 channel on the lower side of the sheet metal casing
14 support web for the heating and cooling tube, connected to the ceiling plate
15 angle section for assembly
16 square tube for installation onto the ceiling
17 longitudinal slot
18 transverse screw on the angle section 15
19 screw nut for the transverse screw 18
20 screw nut for the vertical screw 12
21 cover
22 side wall, thermal separation wall
23 cavity
24 heat contact body
25 movement sheet [metal] (plate)
26 drive means
27 air gap between the heat contact body 24 and the casing 2
28 contact layer
29 capillary tube mat
30 heat conducting ribs
31 supply union for capillary mat 29
32 discharge union for capillary mat 29
33 suspension edging
34 fastening angle
35 transverse struts for grid of angle sections.

1-9. (canceled).

10. A thermoactive wall and ceiling element for installation in rooms of new and existing buildings, comprising a closed casing for intermediately storing heat and containing a phase change material, as a latent heat reservoir, and at least one heating pipe and cooling pipe for controlling a heat exchange between said closed casing and its surroundings, wherein said phase change material is based upon a parafin or a salt hydrate for increasing thermal conductivity in a surrounding region of said phase change material with heat conducting ribs being added to said phase change material for increasing heat conduction capability, said heat-conducting ribs being arranged in heat-conducting contact with said closed casing, between which said at least one heating pipe and cooling pipe of a capillary tube mat extend, said capillary tube mat having connections that are led through a lid of a casing for insert connections, with a remaining side of said closed casing filled with a plaster as a carrier mass, wherein said phase change material is encapsulated in plastic capsules is dispersed, and with a viewed ceiling element being arranged on a lower side of said closed casing.

11. The thermoactive wall and ceiling element for installation in rooms of new and existing buildings according to claim 10, wherein said phase change material further includes graphite.

12. The thermoactive wall and ceiling element for installation in rooms of new and existing buildings according to claim 10, wherein said closed casing on an outer side includes a coating having a flame-inhibiting substance.

13. The thermoactive wall and ceiling element for installation in rooms of new and existing buildings according to claim 12, wherein flame-inhibiting substance is a fireproofing gel.

14. The thermoactive wall and ceiling element for installation in rooms of new and existing buildings according to claim 10, wherein said flame-inhibiting substance is added to said carrier mass.

15. The thermoactive wall and ceiling element for installation in rooms of new and existing buildings according to claim 10, wherein said flame-inhibiting substance is added to said phase change material, as encapsulated.

16. The thermoactive wall and ceiling element for installation in rooms of new and existing buildings according to claim 10, further comprising fillers having a high heat capacity acting as a heat sink added to said carrier mass and said phase change material, so encapsulated.

17. The thermoactive wall and ceiling element for installation in rooms of new and existing buildings according to claim 10, further comprising a heat-conducting lamellar with said at least one heat pipe and cooling pipe integrated into said heat-conducting lamellar and having a vertical lamellae between which a sound absorption material is applied and on lower edges of said sound absorption material is said viewed ceiling element as a viewed ceiling and further comprising a heat exchanger on a room side detachably fastened, is assembled via heat-insulating side walls onto the lower side of said closed casing while leaving a cavity, a heat-conducting heat contact body being arranged in said cavity with said heat-conducting contact body being connected in a heat-conducting manner to a heat-conducting connection with said lower side of said closed casing and an upper side of said heat-conducting lamellar, and drive means for displacing or compressing said heat-conducting heat contact body inside of said cavity, so that said heat-conducting connection with said closed casing, with said heat-conducting lamellar, or with both said closed casing and said heat-conducting lamellar is temporarily separated.

18. The thermoactive wall and ceiling element for installation in rooms of new and existing buildings according to claim 17, wherein said lower side of said closed casing forms an oblique plane having a heat contact layer, and a wedge-like, heat-conducting heat contact body is horizontally displaceably arranged in said cavity, said wedge-like, heat-conducting heat contact body having a lower side in a heat-conducting connection with said upper side of said heat-conducting lamellar, and which said upper side runs parallel to said lower side of said closed casing, with said drive means being accommodated in said cavity, by way of which said wedge-like heat-conducting contact body is displacable inside of said cavity, so that, when required, said wedge-like heat-conducting contact body is able to be brought in a heat-conducting connection with, or be thermally separated from, said lower side of said closed casing.

19. The thermoactive wall and ceiling element for installation in rooms of new and existing buildings according to claim 17, wherein said heat-conducting heat contact body in said cavity includes an elastically compressible material having an expanded condition and, wherein in said expanded condition, is in a heat-conducting connection with said lower side of said closed casing and with said upper side of said lamellar and is passed through horizontally via a movement sheet vertically movable via said drive means, so that either said upper side of said heat-conducting heat contact body, when required, is capable of being brought into a heat conducting connection with, or able to be thermally separated from, said lower side of said closed casing, or said lower side of said heat-conducting heat contact body, when required, is capable of being brought into a heat-conducting connection with, or capable of being thermally separated from, said upper side of said lamellar.

20. The thermoactive wall and ceiling element for installation in rooms of new and existing buildings according to claim 17, wherein said drive means for displacing said heat-conducting heat contact body, or for compressing and expanding said heat-conducting contact body, is electrochemical actuators, electroactive polymers, thermoelectric drive elements, electric motors, motorically driven pull cables, magnetic or hydraulic force cylinders or electroreological fluids.

21. The thermoactive wall and ceiling element for installation in rooms of new and existing buildings according to claim 10, wherein said closed casing comprises a section having a rectangular cross-section closed on both sides in a fluid-tight manner via a lid, said closed case having in said lower side a channel, with a lamellae arranged on said lower side of said closed casing projecting perpendicularly therefrom, between which a sound absorption material is applied, said viewed ceiling element being a viewed ceiling is detachably fastened on lower edges of said lamellae, said viewed ceiling element, via a support web, carrying said at least one heating pipe and cooling pipe running in said channel via a material fit.

22. The thermoactive wall and ceiling element for installation in rooms of new and existing buildings according to claim 10, further comprising a sound absorption material arranged on an upper side of said closed casing with a support design passing through said sound absorption material.

23. The thermoactive wall and ceiling element for installation in rooms of new and existing buildings according to claim 10, wherein said closed casing comprises a section having a rectangular cross-section and closed on both sides in a fluid-tight manner via a lid, said at least one heating pipe and cooling pipe being integrated either inside said section or into a lamellae, which on said lower side of said closed casing either rigidly belonging to said closed casing or assembled on said closed casing in a mobile manner, project perpendicularly from said section, and further comprising a sound absorption material applied between said lamellae, and said viewed ceiling element being detachably fastened on lower edges of said lamellae via spring clips.
